(19) United States
(12) Patent Application Publication
(10) Pub. No.: US 2015/0346453 A1
(43) Pub. Date: Dec. 3, 2015

(54) CAMERA MODULE AND DRIVING CONTROL SYSTEM FOR CAMERA MODULE

(71) Applicant: Samsung Electro-Mechanics Co., Ltd., Suwon-Si (KR)

(72) Inventors: Shin Young CHEONG, Suwon-Si (KR); Jung Seok LEE, Suwon-Si (KR); Jae Ho BAIK, Suwon-Si (KR); Hoon HEO, Suwon-Si (KR); Po Chul KIM, Suwon-Si (KR); Yoo Chang KIM, Suwon-Si (KR)

(73) Assignee: Samsung Electro-Mechanics Co., Ltd., Suwon-Si (KR)

(21) Appl. No.: 14/715,748

(22) Filed: May 19, 2015

(30) Foreign Application Priority Data
Jun. 3, 2014 (KR) 10-2014-0067455
Nov. 7, 2014 (KR) 10-2014-0154796

(51) Int. Cl. G02B 7/02; G02B 7/09

(52) U.S. Cl. CPC G02B 7/023; G02B 7/09

(57) ABSTRACT

A camera module includes a lens barrel, a housing accommodating the lens barrel therein, a ball bearing contacting rolling surfaces, which are respectively provided on the lens barrel and the housing, and a semi-wet lubricant applied to a surface of the ball bearing.

### CROSS-REFERENCE TO RELATED APPLICATIONS

This application claims the benefit under 35 USC 119(a) of Korean Patent Application No. 10-2014-0067455 filed on Jun. 3, 2014, and 10-2014-0154796 filed on Nov. 7, 2014, with the Korean Intellectual Property Office, the disclosure of which are incorporated herein by reference.

### BACKGROUND

1. Field

The following description relates to a camera module and a driving control system for a camera module.

2. Description of Related Art

Recently, portable communications terminals such as cellular phones, personal digital assistants (PDAs), portable personal computers (PCs), and the like, have generally been implemented with the ability to perform the transmission of video data in addition to the transmission of text and audio data. In accordance with this trend, camera modules have come to be commonly installed in the portable communications terminals in order to enable reception of video data, and allow video calls to be made.

Generally, such camera modules include a lens barrel having lenses disposed therein, a housing accommodating the lens barrel, and an image sensor converting an image of a subject into an electrical signal. In addition, a single focus type camera module to capture an image of a subject with a fixed focus may be implemented as the camera module. However, a camera module including actuators to allow auto-focusing to be performed is desired.

The actuators in the camera module are guided by ball bearings, which cause abrasion and vibrations as a result of a hard contact between the ball bearings and a guide surface.

In order to suppress abrasion and vibrations due to the hard contact between the ball bearings and the guide surface, a lubricant may be added. However, in the case of using a pure liquid type lubricant, the lubricant may leak, thereby creating a problem of possibly damaging the camera module. Further, in the case of using a semi-solid type grease lubricant, a ball bearing may act as a sliding bearing rather than a rolling bearing, leading to abnormal operations of the actuator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features and aspects will be apparent from the following detailed description, the drawings, and the claims.

### BRIEF DESCRIPTION OF DRAWINGS

These and/or other aspects will become apparent and more readily appreciated from the following description of the embodiments, taken in conjunction with the accompanying drawings in which:

FIGS. 1A and 1B are exploded perspective views of a camera module, according to an example;

FIG. 2 is a block diagram of the camera module, according to an example;

FIG. 3 is a bode plot illustrating a transfer function of a driving signal to an input signal, according to an example;

FIG. 4 is a bode plot illustrating a transfer function of an output signal to an input signal, according to an example;

FIG. 5 is a bode plot for simulation data, according to an example;

FIGS. 6A and 6B are graphs illustrating displacement and current consumption of a lens barrel to a driving time of the camera module, in accordance with an example;

FIG. 7 is a schematic cross-sectional view of the camera module taken along line A-A′ of FIG. 1, in accordance with an example;

FIG. 8 is a cross-sectional view of a driving part and a controlling part of the camera module taken along line B-B′ of FIG. 1;

FIG. 9 is a plan view illustrating a coil of the camera module of FIG. 1, in accordance with an example; and

FIGS. 10A through 10C are plan views illustrating disposition of the coil and the controlling part, in accordance with an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or methods described herein will be apparent to one of ordinary skill in the art. For example, the sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

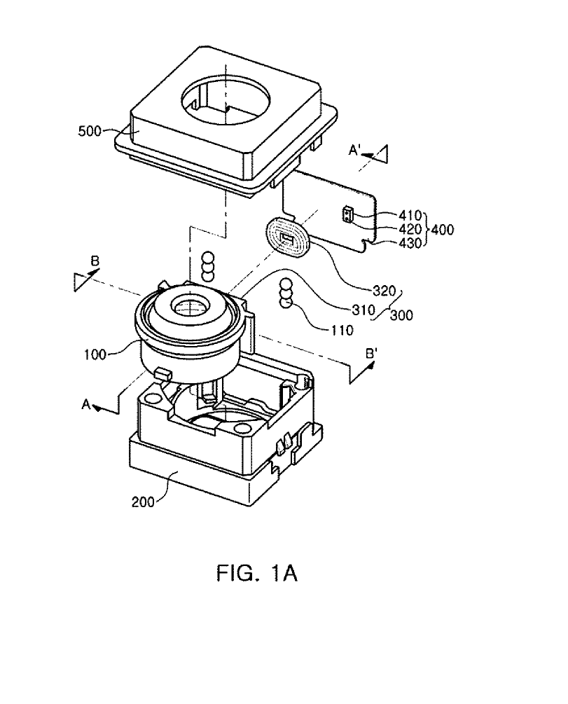

FIGS. 1A and 1B are exploded perspective views of a camera module, according to an example.

Referring to FIG. 1A, the camera module includes a lens barrel 100, a housing 200, a driving part (actuator) 300, and a controlling part 400. The camera module also includes a case 500. For reference, the driving part 300 and the controlling part 400 may be termed as a driving control system for the camera module. For instance, the driving part 300 and the controlling part 400 function in conjunction or independently to drive the lens barrel 100 in an optical axis direction.

Terms with respect to directions will be first defined. An optical axis direction refers to a direction perpendicular with respect to a radial direction of the lens barrel 100.

In one illustrative configuration, the lens barrel 100 has a hollow cylindrical shape so that at least one lens imaging a subject is accommodated therein. The lens in the lens barrel 100 is arranged on an optical axis.

The lens barrel 100 is coupled to the housing 200. For instance, the lens barrel 100 is disposed in the housing 200. The lens barrel 100 moves in the optical axis direction within the housing 200 in order to perform auto-focusing.

The housing 200, which accommodates and supports the lens barrel 100 to be driven in the optical axis direction. Therefore, the configuration of the housing 200 includes an internal space formed to accommodate the lens barrel 100 therein.

Furthermore, at least one ball bearing 110 is provided in the optical axis direction within the lens barrel 100. The at least one ball bearing 110 serves as a guide structural element to guide the driving of the lens barrel 100 when the lens barrel 100 moves in the optical axis direction within the housing 200.

At least one ball bearing 110 is disposed between the lens barrel 100 and the housing 200 and rolled to support the movement of the lens barrel 100 in the optical axis direction. In one illustrative configuration, at least one ball bearing 110 contacts an outer surface (a first rolling surface) of the lens barrel 100 and an inner surface (a second rolling surface) of the housing 200 to guide the movement of the lens barrel 100 in the optical axis direction.

The ball bearing 110 may have a hardness greater than that of the first and second rolling surfaces. For example, the ball bearing 110 is formed using a ceramic material. Also, a semi-wet lubricant may be applied to at least one of the ball bearing 110 and the first and second rolling surfaces.

When the lens barrel 100 moves in the optical axis direction, at least one ball bearing 110 supports the lens barrel 100, such that the lens barrel 100 moves in parallel with the optical axis. The case 500 is coupled to the housing 200 to form an appearance of the camera module, according to an example.

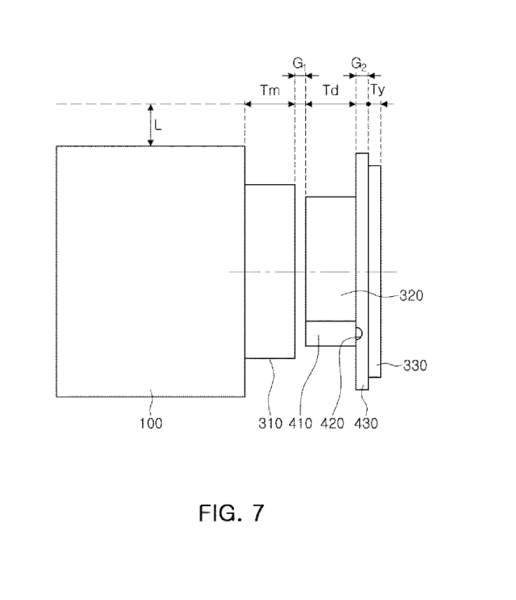

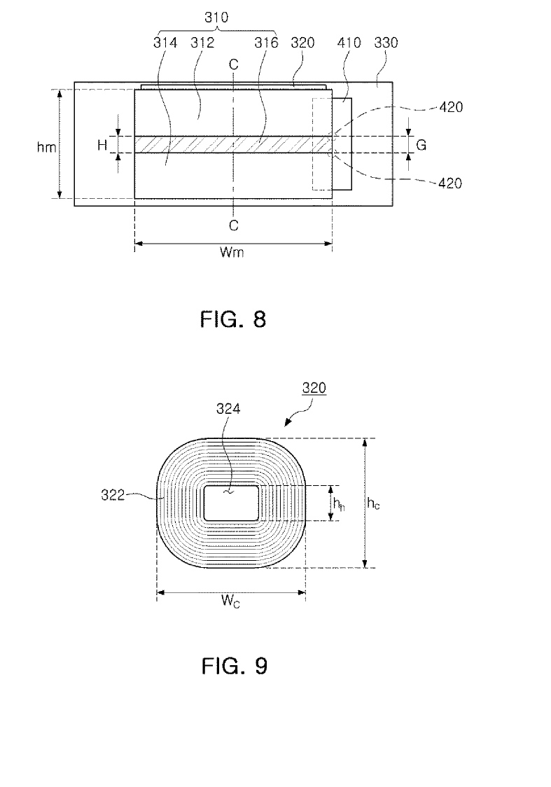

The driving part 300, which is a driving unit moving the lens barrel 100 in the optical axis direction, includes a magnet 310, a coil 320, and a yoke 330 (illustrated in FIGS. 7 and 8).

The magnet 310 is mounted on one side surface of the lens barrel 100, and the coil 320 is disposed in the housing 200 to face the magnet 310. The coil 320 is mounted on a substrate 430 and is disposed to face the magnet 310. In one configuration, the coil 320 may vary in size depending on the size and configuration of the magnet 310. Furthermore, although the coil 320 is configured to be located at a portion of the one surface of the lens barrel 100, a person of ordinary skill in the relevant art will appreciate that the coil 320 may cover a greater surface portion of the one surface of the lens barrel 100. The yoke 330 is mounted on a rear surface of the substrate 430 to prevent leakage of magnetic flux generated between the magnet 310 and the coil 320.

Referring to FIG. 1B, a camera module illustrated in FIG. 1B further includes a holder 200a.

In the camera module illustrated in FIG. 1A, the lens barrel 100 moves in the optical axis direction. On the other hand, in the camera module illustrated in FIG. 1B, the holder 200a, which accommodates therein or contains the lens barrel 100, moves in the optical axis direction within the housing 200.

In the camera module illustrated in FIG. 1A, the magnet 310 is provided on one surface of the lens barrel 100 in order to drive the lens barrel 100 in the optical axis direction. In one configuration, the magnet 310 may vary in size depending on the size and configuration of the lens barrel 100. Furthermore, although the magnet 310 is configured to be located at a portion of the one surface of the lens barrel 100, a person of ordinary skill in the relevant art will appreciate that the magnet 310 may cover a greater surface portion of the one surface of the lens barrel 100. On the other hand, in the camera module illustrated in FIG. 1B, the magnet 310 is provided on one surface of the holder 200a in order to drive the holder 200a, accommodating the lens barrel 100 therein, in the optical axis direction.

In addition, in the camera module illustrated in FIG. 1A, the at least one ball bearing 110 contacts the outer surface of the lens barrel 100 and the inner surface of the housing 200. On the other hand, in the camera module illustrated in FIG. 1B, the at least one ball bearing 100 is provided in the optical axis direction on one surface of the holder 200a in order to guide and support movement of the holder 200a when the holder 200a moves in the optical axis direction within the housing 200. For example, the at least one ball bearing 110 contacts an outer surface (a first rolling surface) of the holder 200a and the inner surface (a second rolling surface) of the housing 200 to guide the movement of the lens barrel 100 in the optical axis direction. In one example, the ball bearing 110 has a hardness greater than that of the first and second rolling surfaces. The ball bearing 110 may be formed of a ceramic material. Further, a semi-wet lubricant may be applied to at least one of the ball bearing 110 and the first and second rolling surfaces.

Because the camera module illustrated in FIG. 1B is similar to the camera module illustrated in FIG. 1A, except that the camera module includes the holder 200a, the camera module illustrated in FIG. 1A will be mainly described below. However, a description provided below may be applied to the camera module illustrated in FIG. 1B.

The controlling part 400 applies a driving signal to the driving part 300 to control electromagnetic interaction between the magnet 310 and the coil 320. In accordance with an illustrative configuration, the controlling part 400 includes a driver integrated circuit (IC) 410 and a sensor 420, and further includes the substrate 430. The driver IC 410 and the sensor 420 are mounted on the substrate 430 to face the magnet 310, and the substrate 430 may be fixed or operatively connected to the housing 200. The sensor 420 detects a position of the magnet 310 and may include, for example, a hall sensor.

Next, the semi-wet lubricant that is applied to at least one of the ball bearing 110 and the first and second rolling surfaces will be described in more detail.

In one embodiment, the semi-wet lubricant is formed on at least one of the ball bearing 110 and the first and second rolling surfaces. The semi-wet lubricant is prepared by mixing a solvent with a lubricant. A mixture of the solvent and the lubricant is applied to specific surfaces, such as a surface of the ball bearing 110 and the first and second rolling surfaces. The solvent is evaporated and removed from the mixture at room temperature.

For example, when the ball bearing 110 is immersed in a mixed solution prepared by mixing a lubricant having a specific gravity of 5 with a solvent having a specific gravity of 100 or the mixed solution is applied to the first and second rolling surfaces and is then dried, a semi-wet lubricant is obtained having a thin coating.

In one example, the lubricant mixed with the solvent is a fluorine-based lubricant that may contain, for example, polytetrafluoroethylene (PTFE). The semi-wet lubricant prepared by mixing the fluorine-based lubricant with the solvent and evaporating the mixed solution may be a fluorine-based lubricant. In an alternative example, the semi-wet lubricant may be a silicon-based lubricant.

Unlike liquid, the semi-wet lubricant may be in a state in which the semi-wet lubricant does not flow or flows from a location to which the semi-wet lubricant was applied. In the alternative, unlike solid or semi-solid type lubricants, the semi-wet lubricant may be in a state in which the semi-wet lubricant does not flow through a portion or surface onto which the semi-wet lubricant was applied. As a result, at least one of the surface of the ball bearing 110 and the first and second rolling surfaces may be coated with the semi-wet lubricant.

A thickness of the semi-wet lubricant may be 0.5 to 10 μm, and a kinematic viscosity thereof may be 400 to 900 cSt at a temperature of 40° C. In addition, flow-down of the semi-wet lubricant may be 3 cm or less. The flow-down indicates a distance of flow of a lubricant when a stainless steel (SUS) plate is positioned vertically after 0.1 ml of lubricant has been applied to the stainless steel (SUS) plate.

In the camera module, according to an example, the semi-wet lubricant may be applied to at least one of the surface of the ball bearing 110 and the first and second rolling surfaces to solve a problem such as lubrication leakage to improve reliability of a product.

In addition, a phenomenon in which the ball bearing 110 and the first and second rolling surfaces are stuck to each other, which may occur at the time that a solid type lubricant is used, may be removed to decrease friction and vibrations. As the friction and the vibrations are decreased, a first resonance peak decreases, such that a position of the lens barrel may be stably controlled.

Further, according to an example, because the semi-wet lubricant is applied to at least one of the surface of the ball bearing 110 and the first and second rolling surfaces, a control value provided to the driving part 300, which drives the lens barrel 100 in the optical axis direction through the ball bearing 110 and the first and second rolling surfaces, is optimized depending on the use of the semi-wet lubricant.

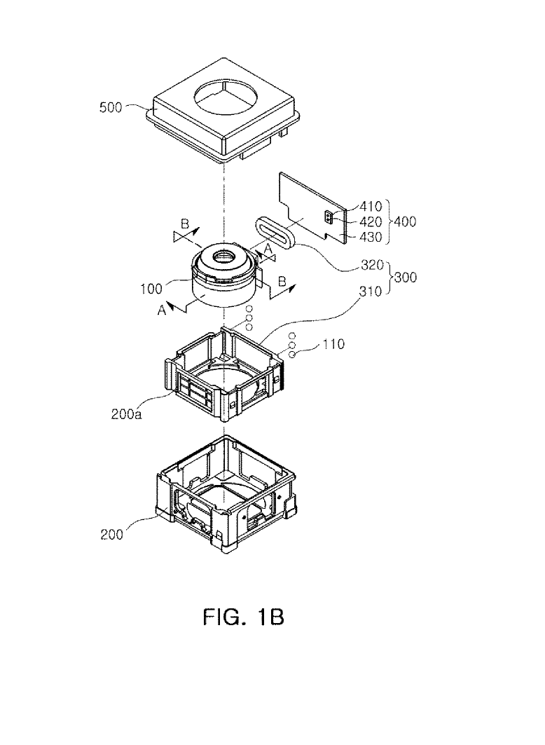

FIG. 2 is a block diagram of the camera module, according to an example.

The driver IC 410 may receive an input signal applied from the outside and a feedback signal generated from the sensor 420 and generate a driving signal for controlling the driving part 300.

The driver IC 410 may control the driving part 300 in an initial operation mode, an auto-focusing mode, and a maintaining mode. The initial operation mode corresponds to a mode for maintaining an initial position of the lens barrel, the auto-focusing mode corresponds to a mode for moving the lens barrel from the initial position to a target position, and the maintaining mode corresponds to a mode for maintaining the position of the lens barrel at the target position.

In the following description, a scheme in which the driver IC 410 controls the driving part 300 in the auto-focusing mode and the maintaining mode among the initial operation mode, the auto-focusing mode, and the maintaining mode will be mainly described.

The driver IC 410 may perform a control using a proportional integral derivative (PID) scheme based on the input signal and the feedback signal. In addition, the driver IC 410 may include a low pass filter to perform a control using a low pass filter scheme of passing only a frequency component of a specific frequency or less of the input signal therethrough.

The following Mathematical Expression 1 represents a transfer function of the driver IC 410, for example, a transfer function of the driving signal to the input signal. In detail, the following Mathematical Expression 1 represents a transfer function when the driver IC performs the control using the PID scheme. In the following Mathematical Expression 1, K(s) indicates the transfer function of the driving signal to the input signal, K_{P} indicates a proportional control gain, K_{I} indicates an integral control gain, and K_{D} indicates a differential control gain.

$$K ( s ) = {K}_{p} + \frac{1}{{K}_{{I}^{S}}} + {K}_{{D}^{S}} \qquad Mathematical Expression 1$$

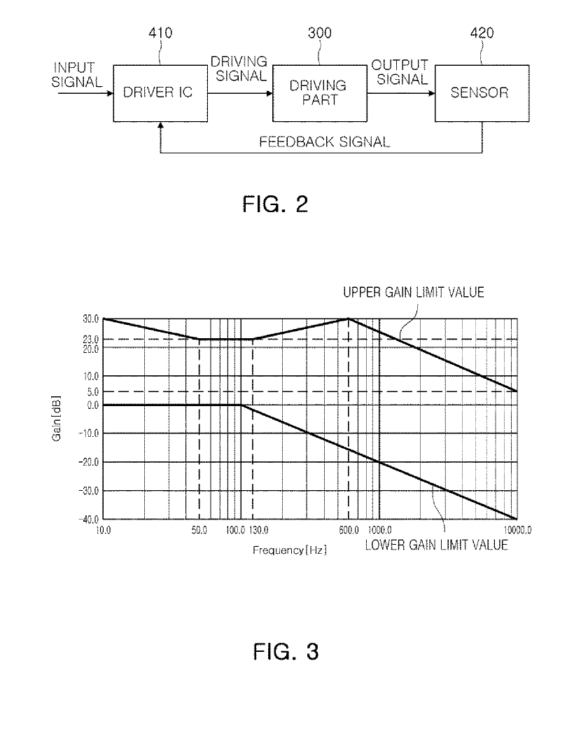

FIG. 3 is a bode plot illustrating a transfer function of a driving signal to an input signal according to an example.

Referring to FIG. 3, the transfer function of the driving signal to the input signal may have an upper gain limit value and a lower gain limit value as illustrated in FIG. 3. The driver IC 410 may perform the control using the PID scheme and the control using the low pass filter scheme, based on a specific frequency, to set the upper gain limit value, and may perform the control using the low pass filter scheme based on a specific frequency to set the lower gain limit value.

For example, the driver IC 410 may perform the control using the PID scheme at a frequency less than 600 Hz and perform the control using the low pass filter scheme at a frequency of 600 Hz or more to set the upper gain limit value.

The upper gain limit value may be 30 dB at 10 Hz, may be decreased to about 23 dB from 10 Hz to 50 Hz, and may be maintained as 23 dB from 50 Hz to about 130 Hz, and may then be increased to 30 dB from 130 Hz to 600 Hz. Then, the upper gain limit value may be decreased after 600 Hz, and in more detail, may be decreased at a gradient of −20 dB/decade or less at 1 kHz or more, such that the upper gain limit value may be about 5 dB at 10 kHz.

In addition, the lower gain limit value may be 0 dB or more at 100 Hz or less. In detail, the lower gain limit value may be maintained as 0 dB from 10 Hz to 100 Hz and may be linearly decreased at 100 Hz or more, such that the lower gain limit value may be −40 dB at 10 kHz.

Considering the upper gain limit value and the lower gain limit value, a gain at 10 Hz may be 0 to 30 dB, and a bandwidth may be 80 Hz or more.

Referring back to FIG. 2, the driving part 300 may drive the lens barrel 100 depending on the driving signal provided from the driver IC 410 to generate an output signal. The driving part 300 includes the magnet 310 and the coil 320. When a driving voltage corresponding to the driving signal is applied to the coil 320 through the substrate 430, the driving force may be generated by electromagnetic interaction between the magnet 310 and the coil 320 to move the lens barrel 100 in the optical axis direction. The sensor 420 may detect the movement of the magnet to generate the feedback signal and provide the generated feedback signal to the driver IC 410.

The following Mathematical Expression 2 represents a transfer function of the driving part 300, for example, the output signal to the driving signal. In the following Mathematical Expression 2, G_{VCM}(S) indicates the transfer function, ζᵢ indicates a damping ratio, and ωₙᵢ indicates a natural frequency.

$${G}_{VCM} ( s ) = {\sum }_{i = 1}^{m} \frac{{ω}_{ni}^{2}}{{s}^{2} + 2 {ζ}_{i} {ω}_{ni} s + {ω}_{ni}^{2}} \qquad Mathematical Expression 2$$

The following Mathematical Expression 3 represents a transfer function of the output signal to the input signal, calculated based on Mathematical Expression 1 and Mathematical Expression 2. In the following Mathematical Expression 3, G(s) indicates the transfer function of the output signal to the input signal.

$$G ( s ) = K ( s ) {G}_{VCM} ( s ) = ( {K}_{p} + \frac{{K}_{I}}{s} + {K}_{{D}^{S}} ) ( {\sum }_{i = 1}^{m} \frac{{ω}_{ni}^{2}}{{s}^{2} + 2 {ζ}_{i} {ω}_{ni} s + {ω}_{ni}^{2}} ) \qquad Mathematical Expression 3$$

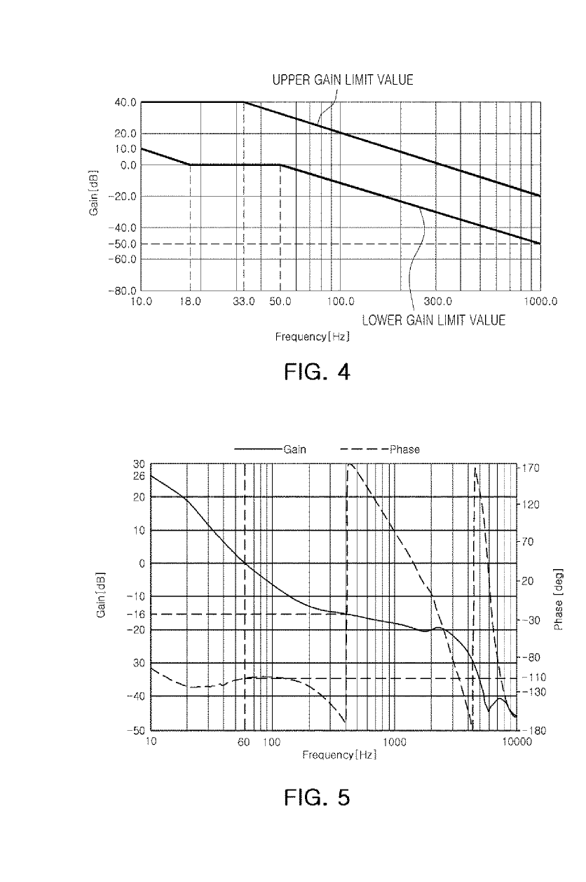

FIG. 4 is a bode plot illustrating a transfer function of an output signal to an input signal according to an example.

The transfer function of the output signal to the input signal may have an upper gain limit value and a lower gain limit value as illustrated in FIG. 4. The upper gain limit value may be 40 dB at 10 Hz, may be maintained as 40 dB from 10 Hz to about 33 Hz, and then may be linearly decreased to be −20 dB at 1000 Hz. In this example, a gain crossover frequency of the upper gain limit value is 300 Hz or less. A gradient in a frequency region greater than the gain crossover frequency of the upper gain limit value may be −40 dB/decade or less.

In accordance with one configuration, the lower gain limit value is about 10 dB at 10 Hz, is linearly decreased to about 0 dB from 10 Hz to about 18 Hz, is maintained as 0 dB from about 18 Hz to 50 Hz or more, and then decreases to about −50 dB from 50 Hz or more to 1000 Hz. A gain crossover frequency of the lower gain limit value may be 50 Hz or more. A gradient in a frequency region greater than 300 Hz may be −40 dB/decade or less. In addition, a gradient in a frequency region greater than the gain crossover frequency of the upper gain limit value may be −40 dB/decade or less.

By taking into consideration the upper gain limit value and the lower gain limit value, a gain at 10 Hz may be 10 to 40 dB, and a gain crossover frequency may be 50 Hz or more to 300 Hz or less. In addition, a phase margin may be set to 45 degrees or more, and a gain margin may be set to 10 dB or more.

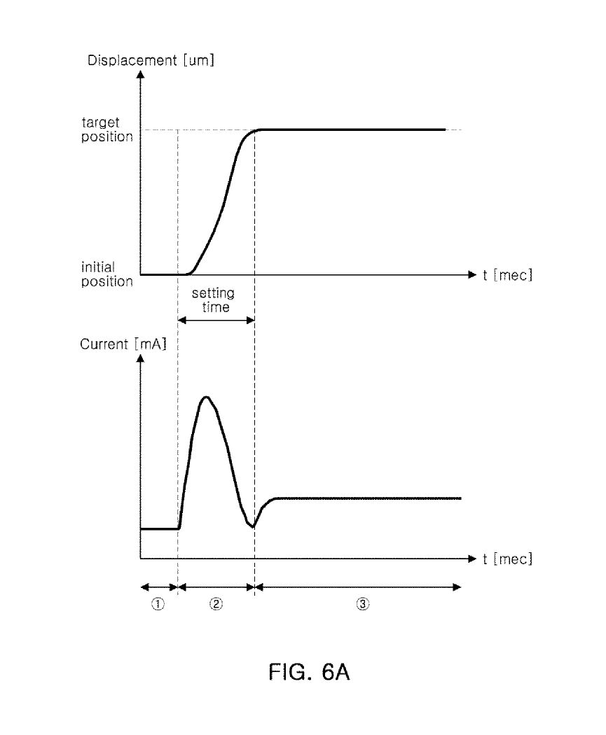

FIG. 5 is a bode plot for simulation data according to an exemplary embodiment. In detail, FIG. 5 is a bode plot illustrating a transfer function and a phase of an output signal to an input signal.

Referring to FIG. 5, it may be appreciated that a gain at 10 Hz corresponds to 26 dB, which is positioned between the upper gain limit value and the lower gain limit value illustrated in FIG. 4. Since a high gain is secured at a low frequency in the vicinity of 10 Hz to implement a short settling time, the camera module may rapidly enter a stable operation mode.

In addition, a gain crossover frequency is 60 Hz, which is positioned in a range of the gain crossover frequency of the upper gain limit value and the lower gain limit value illustrated in FIG. 4. In this case, a phase margin may be 70 degrees, and a gain margin may be 16 dB. According to an example, a high phase margin and a gain margin may be secured, such that the camera module may be stably operated in a wide range.

Next, a result of a driving test of the camera module according to an exemplary embodiment.

The following Table 1 illustrates the results of driving tests of camera modules according to types of lubricants used. Here, all of the components of the camera modules according to Embodiment 1 of the present disclosure and Comparative Examples 1 to 5 except for whether or not a lubricant is present and the types of lubricant were operated under the same conditions. For example, all control values applied to Embodiment 1 and Comparative Examples 1 to 5 may be the same as each other. Here, the control values may be set using the transfer value as described above with reference to FIGS. 3 and 4.

Embodiment 1 corresponds to the case in which a semi-wet lubricant is used, Comparative Example 1 corresponds to the case in which a lubricant is not used, Comparative Example 2 corresponds to the case in which a solid type lubricant is used, Comparative Examples 3 and 4 correspond to the case in which a liquid type lubricant is used, and Comparative Example 5 corresponds to the case in which a fluorine-based semi-solid type lubricant is used.

TABLE 1

| | | Non- | Settling | Oscillation | Lubricant |
|---|---|---|---|---|---|
| | Kind of | driving | Time | Instability | Leakage |
| | Lubricant | [Number] | [msec] | [Number] | [Number] |
| Embodi- | Fluorine- | 0 | 11.8 | 0 | 0 |
| ment 1 | based | | | | |
| | (Semi-wet) | | | | |
| Comparative | Lubricant | 0 | 14.2 | 6 | 0 |
| Example 1 | not used | | | | |
| Comparative | Solid | 0 | 13.4 | 8 | 0 |
| Example 2 | | | | | |
| Comparative | Mineral | 0 | 16.2 | 4 | 6 |
| Example 3 | Oil Based | | | | |
| Comparative | Synthetic | 0 | 15.7 | 5 | 7 |
| Example 4 | Oil Based | | | | |
| Comparative | Fluorine- | 2 | 19.7 | 0 | 0 |
| Example 5 | based | | | | |
| | (Semi-solid) | | | | |

According to an example, when a fluorine-based semi-wet lubricant is used, a settling time may be less than 12 msec. It may be appreciated from Table 1 that in the case of Embodiment 1, problems such as non-driving, oscillation instability, and lubricant leakage did not occur in a driving test of the driving part, and a settling time was 11.8 msec, which was the shortest time, such that a camera module having excellent performance and stability may be implemented.

On the other hand, it may be appreciated that settling times in Comparative Examples 1 to 5 were longer than the setting time in Embodiment 1, and in the case of Comparative Examples 1 to 4, a problem occurred in an oscillation instability test, such that oscillation sound (noise) may be generated at the time of driving the camera module. In addition, it may be confirmed that in the case of Comparative Examples 3 and 4, in which a liquid type lubricant was used, lubricant leakage occurs. In the case of Comparative Example 5, the camera module was not driven.

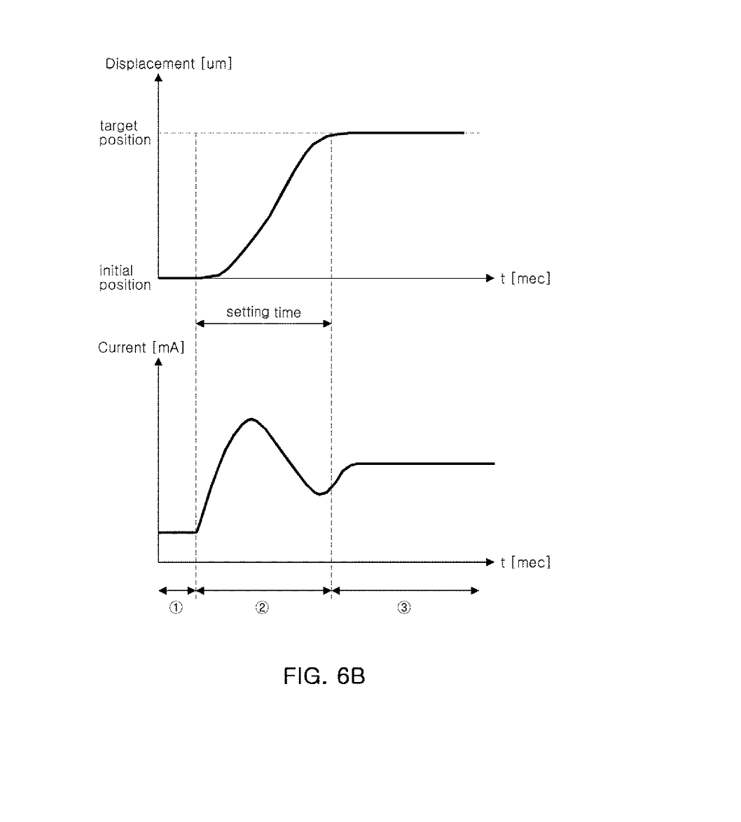

Next, driving characteristics of camera modules of Embodiment 1 and Comparative Example 4 will be compared with each other in detail with reference to FIG. 6.

FIGS. 6A and 6B are graphs illustrating displacement and current consumption of a lens barrel to a driving time of the camera module, in accordance with an example.

FIG. 6A is a graph of the camera module according to Embodiment 1 using a semi-wet lubricant as a lubricant, and FIG. 6B is a graph of the camera module according to Comparative Example 4 using a synthetic oil based lubricant as a lubricant. In FIGS. 6A and 6B, section \hat{1} corresponds to an initial operation mode, section \hat{2} corresponds to an auto-focusing mode for moving the lens barrel from an initial position to a target position, and section \hat{3} corresponds to a mode for maintaining the lends in the target position.

It may be appreciated from Table 1 and FIGS. 6A and 6B that in the case of Embodiment 1 of FIG. 6A, a settling time required for moving the lens barrel from the initial position to the target position is 11.8 msec, and in the case of Comparative Example 4 of FIG. 6B, a settling time is 15.7 msec. Therefore, it can be observed that the settling time in Embodiment 1 of FIG. 6A is shorter than the settling time in Comparative Example 4 of FIG. 6B. In addition, it may be appreciated that an amount of current consumed in maintaining an operation after the lens barrel reaches the target position is smaller in Embodiment 1 than Comparative Example 4.

In further detail, Comparative 4 of FIG. 6B corresponds to the case in which the synthetic oil based lubricant is used as the lubricant. Here, the synthetic oil based lubricant is filled between the ball bearing and the rolling surface to hinder a normal rolling operation of the ball bearing.

Therefore, the ball bearing is not rolled on the rolling surface, but is instead slid without being rotated. This sliding operation of the ball bearing causes an increase in frictional force and current consumption. Therefore, Comparative 4 of FIG. 6B may be more disadvantageous in terms of a settling time and current consumption than the case of Embodiment 1 of FIG. 6A.

The following Table 2 illustrates comparison results of driving tests of camera modules depending on characteristics of a semi-wet lubricant. Here, all of the components of the camera modules except for the characteristics of the semi-wet lubricant were operated under the same conditions. For example, all of the control values of the controlling part 400 applied to Samples 1 to 7 may be the same as each other. Here, the control values may be set using the transfer value as described above with reference to FIGS. 3 and 4.

TABLE 2

| | |
|---|---|
| Condition | Test Result |

| | Kinematic | Flow- | Settling | Oscillation |
|---|---|---|---|---|
| | Viscosity | Down | Time | Instability |
| | [cSt at 40° C.] | [cm] | [msec] | [Number] |
| Sample 1* | 2000 | 0 | 19.7 | 0 |
| Sample 2 | 900 | 2.3 | 11.8 | 0 |
| Sample 3 | 800 | 2.6 | 12.6 | 0 |
| Sample 4 | 600 | 3.1 | 12.9 | 0 |
| Sample 5 | 400 | 2.8 | 14.3 | 0 |
| Sample 6* | 200 | 3.6 | 16.3 | 1 |
| Sample 7* | 70 | 3.3 | 15.2 | 4 |
| Sample 8* | 60 | 5.1 | 16.9 | 5 |
| Sample 9* | 20 | 13.6 | — | 8 |

*Comparative Example

Referring to Table 2, Samples 2 to 5, having kinematic viscosities of 900 cSt, 800 cSt, 600 cSt, and 400 cSt and flow-down of 2.3 cm, 2.6 cm, 3.1 cm, and 2.8 cm, respectively, correspond to the examples, while Samples 1 and 6 to 9, which have kinematic viscosities and flow-down outside of a numerical range according to the examples, correspond to Comparative Examples.

It may be appreciated that in the case of Samples 2 to 5, a problem such as oscillation instability is not present in the driving test of the camera module. Additionally, the settling times are shorter as compared with the Comparative Examples, such that a camera module having excellent performance and stability may be implemented according to an examples.

In the case of Samples 1 and 6 to 9, the setting times are relatively long, such that the camera modules may not rapidly reach a target level, and in the case of Samples 6 to 9, a problem with oscillation instability occurs, such that an oscillation sound (noise) may be generated at the time of driving an actuator.

As described above the camera module according to an example has excellent performance and stability achieved by applying the semi-wet lubricant to the ball bearing and the rolling surfaces.

FIG. 7 is a schematic cross-sectional view of the camera module according to an example taken along line A-A′ of FIG. 1. The displacement of components of the camera module according to an example will be described.

The magnet 310, the coil 320, and the yoke 330 may be disposed to be spaced apart from each other by predetermined gaps. For example, the magnet 310 and the coil 320 are disposed to be spaced apart from each other by a first gap G1, and the coil 320 and the yoke 330 may be disposed to be spaced apart from each other by a second gap G2. In addition, the magnet 310 and the sensor 420 are disposed to be spaced apart from each other by a third gap (G1+Td).

In FIG. 7, reference numerals Tm, Td, and Ty are a thickness of the magnet 310, a thickness of the driver IC 410, and a thickness of yoke 330, respectively. As an example, G1 is 0.15 mm, Tm is 0.45 mm, Td is 0.45 mm, and Ty is 0.13 mm. Therefore, a distance between the magnet 310 and the sensor 420 may be approximately 0.6 mm.

The sensor 420 may be disposed to substantially face the magnet 310. Alternatively, the sensor 420 may be disposed in a zone in which the sensor 420 may sense magnetic flux density of the magnet 310. For example, the sensor 420 may be disposed between the magnet 310 and the coil 320 or on one side of the coil 320 to sense the magnetic flux density of the magnet 310. However, the sensor 420 is not limited to being disposed on one side of the coil 320. For example, the sensor 420 may be disposed on a line connecting a bisector of the magnet 310 and a bisector of the coil 320 to each other.

FIG. 8 is a cross-sectional view of a driving part and a controlling part of the camera module taken along line B-B′ of FIG. 1. Next, a shape of the magnet 310 will be described with reference to FIGS. 1, 7, and 8.

The magnet 310 may have a predetermined size. For example, the magnet 310 may have a thickness Tm of a first size, a height hm of a second size, and a width Wm of a third size. As an example, the thickness Tm of the magnet 310 may be 0.45 mm, the height hm thereof may be 2.7 mm, the width Wm thereof may be 4.5 mm. However, the thickness, the height, and the width of the magnet 310 are not limited to the above-mentioned numerical values, but may be changed depending on a driving distance of the actuator.

The magnet 310 may be a magnet formed through surface dipole magnetization. For example, a first zone 312 having a first polarity may be formed as one side region of the magnet 310, and a second zone 314 having a second polarity may be formed as the other side region thereof. In addition, a neutral zone 316 that substantially lacks a polarity may be formed between the first and second zones 312 and 314.

The neutral zone 316 may have a height H of a predetermined size. As an example, the height H of the neutral zone 316 may be 0.4 to 0.8 mm. As another example, the height H of the neutral zone 316 may be 0.55 to 0.65 mm. However, a person of ordinary skill in the relevant art will appreciate that the height H of the neutral zone 316 may be of any other dimension suitable for appropriate use and thus not limited to the dimensions described above.

The height H of the neutral zone 316 satisfies the following Relational Expression with respect to the height hm of the magnet 310.

0.14<H/hm<0.32 [Relational Expression]

Alternatively, the height H of the neutral zone 316 satisfies the following Relational Expression with respect to the height hm of the magnet 310.

0.19<H/hm<0.26 [Relational Expression]

In addition, the height H of the neutral zone 316 satisfies the following Relational Expression with respect to the driving distance L of the actuator.

0.89<H/L<2.67 [Relational Expression]

Alternatively, the height H of the neutral zone 316 satisfies the following Relational Expression with respect to the driving distance L of the actuator.

1.22<H/L<2.17 [Relational Expression]

Next, a dispositional form of the sensor will be described with reference to FIG. 8.

The sensor 420 senses the magnetic flux density of the magnet 310. To this end, the sensor 420 is disposed to face the magnet 310. For example, the sensor 420 is disposed in the housing 200 through the substrate 430. However, a position in which the sensor 420 is disposed is not limited to the housing 200. For example, when the magnet 310 is disposed in the housing 200, the sensor 420 is disposed in the lens barrel 100.

The sensor 420 is disposed to substantially face the neutral zone 316 of the magnet 310. For example, at least one sensor 420 is disposed to face the neutral zone 316 of the magnet 310 even in a case in which the lens barrel 100 moves in the optical axis direction. In this case, the sensor 420 accurately senses a change in the magnetic flux density depending on the movement of the lens barrel 100. In addition, the dispositional form of the sensor 420 described above allows the change in the magnetic flux density in a driving range of the lens barrel 100 to have linearity. For example, a driving displacement of the lens barrel 100 in the driving range of the lens barrel 100 may be proportional to a magnitude of the magnetic flux density sensed by the sensor 420. Therefore, when the magnitude of the magnetic flux density sensed by the sensor 420 is recognized, the driving displacement (for example, the current position) of the lens barrel 100 may be recognized. Therefore, according to the example, the magnitude of the magnetic flux density formed between the magnet 310 and the coil 320 may be changed to accurately drive the lens barrel 100 to a desired position, thereby accurately adjusting a focal length of the camera module.

The sensor 420 is disposed to be offset to one side of the magnet 310. However, the sensor 420 may also be disposed at a position that substantially coincides with a central axis C of the magnet 310, if necessary. The dispositional form of the sensor 420 described above may allow the change in the magnetic flux density between the magnet 310 and the coil 320 to be precisely sensed thereby and may not have an influence on the change in the magnetic flux density between the magnet 310 and the coil 320.

The number of sensors 420 is not limited to one sensor and thus many sensors 420 may be provided. For example, the number of sensors 420 may be two. The sensors 420 may be disposed to be spaced apart from each other by a predetermined gap G in a height direction of the magnet 310. A gap G between the sensors 420, for example, first and second sensors 420 and 420, may be 0.30 to 0.34 mm.

The gap G between the sensors 420 satisfies the following Relational Expression with respect to the height H of the neutral zone 316 of the magnet 310.

1.18<H/G<2.67 [Relational Expression]

In addition, the gap G between the sensors 420 may satisfy the following Relational Expression with respect to the height H of the neutral zone 316 of the magnet 310.

1.62<H/G<2.17 [Relational Expression]

The sensor 420 is disposed to be spaced apart from the magnet 310 by a predetermined distance (S=L1+Td). For example, the sensor 420 may face the magnet 310 and be spaced apart from the magnet 310 by a distance S of 0.27 to 0.67 mm.

The distance S between the sensor 420 and the magnet 310 satisfies the following Relational Expression with respect to the height H of the neutral zone 316 of the magnet 310.

0.60<H/S<2.96 [Relational Expression]

In addition, the distance S between the sensor 420 and the magnet 310 satisfies the following Relational Expression with respect to the height H of the neutral zone 316 of the magnet 310.

0.82<H/S<2.41 [Relational Expression]

Meanwhile, the sensor 420 is disposed on the driver IC 410. For example, the sensor 420 may be formed integrally with the driver IC 410 on one surface or a rear part of the driver IC 410. However, a position of the sensor 420 is not limited to the driver IC 410. For example, the sensor 420 may be positioned separately from the driver IC 410.

The sensor 420 is disposed to be spaced apart from the yoke 330 by a predetermined distance. For example, the sensor 420 may be disposed to be spaced apart from the yoke 330 by a distance of 0.2 to 0.4 mm. For reference, a thickness of the yoke 300 may be 0.1 to 0.15 mm.

The sensor 420 senses magnetic flux density in a predetermined range. For example, the sensor 420 may sense magnetic flux density of −300 to 300 mT.

A maximum magnetic flux density Sf sensed by the sensor 420 may satisfy the following Relational Expressions with respect to the height H of the neutral zone 316 of the magnet 310.

−3.0<Sf/(S*H)<0.6 [Relational Expression]

−0.1<Sf/(Wm*H)<0.1 [Relational Expression]

2.79<(Mf*H)/(Sf*S)<13.83 [Relational Expression]

3.83<(Mf*H)/(Sf*S)<11.23 [Relational Expression]

Here, Sf is a maximum magnetic flux density T sensed by the sensor 420, Mf is magnetic flux density T of the magnet 310, S is a distance [mm] between the magnet 310 and the sensor 420, Wm is a width [mm] of the magnet 310, and H is a height [mm] of the neutral zone 316.

For reference, in the exemplary embodiment, the magnetic flux density of the magnet 310 is 1.4 T.

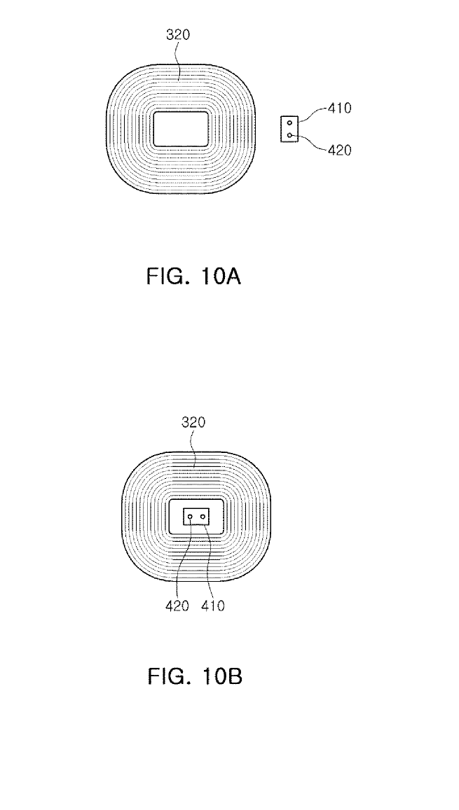

FIG. 9 is a plan view illustrating a coil of the camera module according to an exemplary embodiment of FIG. 1.

The coil 320 may have a size that is the same as or similar to that of the magnet 310. For example, a height h_{c} of the coil 320 may be the same as or similar to the height hₘ of the magnet 310, and a width W_{c} thereof may be the same as or similar to the width Wm of the magnet 310. In addition, a thickness of the coil 320 may be substantially the same as the thickness Tm of the magnet 310. For reference, in the exemplary embodiment, h_{c} may be 2.75 mm, W_{c} may be 3.3 mm, and the thickness of the coil 320 may be 0.45 mm.

The coil 320 has a form in which a plurality of conductive lines 322 are wound. For example, the coil 320 may have a form in which a line having a diameter of 0.04 mm is wound 180 to 240 times. The coil 320 may be formed by being wound 180 to 240 times. However, the number of windings of the coil is not limited thereto and thus the coil may be wound less than 180 times or more than 240 times. Furthermore, the coil 320 may have a predetermined resistance. For example, in one embodiment the coil 320 may have a resistance of 15 to 30 Ω.

The coil 320 may have a hollow part 324 formed at the center thereof. The hollow part 324 may have a height that is substantially the same as or similar to the height H of the neutral zone 316. For example, in the exemplary embodiment the height hₕ of the hollow part 324 may be 0.5 to 0.7 mm, and may satisfy the following Relational Expression with respect to the height H of the neutral zone 316.

0.5<H/hₕ<1.5 [Relational Expression]

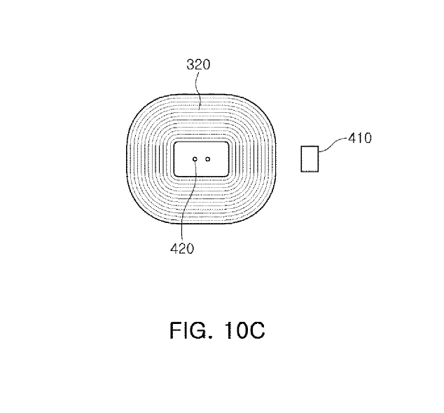

FIGS. 10A through 10C are plan views illustrating dispositions of the coil and the controlling part, in accordance with an embodiment. The coil 320, the driver IC 410, and the sensor 420 will be described with reference to FIGS. 10A through 10C.

Referring to FIG. 10A, the sensor 420 is integrated with the driver IC 410 and be disposed outwardly of the coil 320. In addition, referring to FIG. 10B, the sensor 420 may be integrated with the driver IC 410 and be disposed in the hollow part 324 of the coil 320. Further, referring to FIG. 10C, the driver IC 410 and the sensor 420 may be separated from each other, such that the driver IC 410 may be disposed on the outer side of the coil 320 and the sensor 420 may be disposed in the hollow part 324 of the coil 320.

As set forth above, according to exemplary embodiments, a semi-wet lubricant is applied to at least one of a ball bearing and rolling surfaces, whereby a camera module having excellent performance and stability may be provided.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

The apparatuses, units, modules, devices, parts, and other components illustrated in FIGS. 1A, 1B, 2, 7, 8, 9, 10A, 10B and 10C that perform the operations described herein with respect to FIGS. 3, 4, 5, 6A, and 6B may be implemented using hardware components. The hardware components may include, for example, controllers, sensors, generators, drivers, and any other electronic components known to one of ordinary skill in the art. The hardware components may be implemented using one or more processors. A processor may be implemented, for example, by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. One or more computers may be used as the processor. A processor may include or be connected to one or more memories storing instructions or software to be executed by the processor. The hardware components may execute instructions or software, such as an operating system (OS) and one or more software applications that run on the OS, to perform the operations described herein with respect to FIGS. 3, 4, 5, 6A, and 6B. The hardware components may also access, manipulate, process, create, and store data in response to execution of the instructions or software. For simplicity, the singular term “processor” may be used in the description of the examples described herein, but one of ordinary skill in the art will understand that multiple processors may be used, and that a processor or hardware component may include multiple processing elements and multiple types of processing elements. For example, a hardware component may include multiple processors, or a processor and a controller. In addition, a hardware component may include any one or more of a variety of different processing configuration, such as, a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3, 4, 5, 6A, and 6B that perform the operations described herein with respect to FIGS. 1A, 1B, 2, 7, 8, 9, 10A, 10B and 10C may be performed by a processor or a computer as described above executing instructions or software to perform the operations described herein.

Instructions or software to control a processor or computer to implement the hardware components and perform the methods as described above may be written as computer programs, code segments, instructions or any combination thereof, for individually or collectively instructing or configuring the processor or computer to operate as a machine or special-purpose computer to perform the operations performed by the hardware components and the methods as described above. The instructions or software may include machine code that may be directly executed by the processor or computer, such as machine code produced by a compiler, and higher-level code that may be executed by the processor or computer using an interpreter. Programmers of ordinary skill in the art can readily write the instructions or software based on the block diagrams and the flow charts illustrated in the drawings and their corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. The instructions or software and any associated data, data files, and data structures may be distributed over network coupled computer systems so that the instructions and software and any associated data, data files, and data structures may be stored, accessed, and executed in a distributed fashion by the processor or computer.

What is claimed is:

1. A camera module comprising:
a lens barrel;
a housing accommodating the lens barrel therein;
a ball bearing contacting rolling surfaces, which are respectively provided on the lens barrel and the housing; and
a semi-wet lubricant applied to a surface of the ball bearing.

2. The camera module of claim 1, wherein the semi-wet lubricant is at least one of a silicon-based lubricant and a fluorine-based lubricant.

3. The camera module of claim 1, wherein the semi-wet lubricant contains polytetrafluoroethylene (PTFE).

4. The camera module of claim 1, wherein the semi-wet lubricant is applied to the rolling surfaces of the lens barrel and the housing.

5. The camera module of claim 1, wherein a thickness of the semi-wet lubricant is 0.5 to 10 μm.

6. The camera module of claim 1, wherein a kinematic viscosity of the semi-wet lubricant is 400 to 900 cSt at a temperature of 40° C.

7. The camera module of claim 1, wherein flow-down of the semi-wet lubricant is 3 cm or less.

8. A driving controller for a camera module, the driving controller comprising:
a driving part comprising a magnet provided on one side surface of a lens barrel of the camera module and a coil disposed to face the magnet and configured to move the lens barrel in an optical axis direction; and
a controlling part configured to generate a driving signal in response to an input signal and to provide the driving signal to the driving part to control the driving part,
wherein a gain crossover frequency of a transfer function of an output signal to the input signal depending on driving of the driving part is 50 Hz to 300 Hz.

9. The driving controller for the camera module of claim 8, wherein a gain of the transfer function of the output signal to the input signal is 10 dB to 40 dB at 10 Hz.

10. The driving controller for the camera module of claim 8, wherein the transfer function of the output signal to the input signal is decreased at a gradient of −40 dB/decade or less in a frequency region having a frequency greater than a gain crossover frequency of an upper gain limit value.

11. The driving controller for the camera module of claim 8, wherein a phase margin of the transfer function of the output signal to the input signal is 45 degrees or more.

12. The driving controller for the camera module of claim 8, wherein a gain margin of the transfer function of the output signal to the input signal is 10 dB or more.

13. The driving controller for the camera module of claim 8, wherein a bandwidth of a transfer function of the driving signal to the input signal is 80 Hz or more.

14. The driving controller for the camera module of claim 8, wherein a gain of a transfer function of the driving signal to the input signal is 10 dB to 30 dB at 10 Hz.

15. The driving controller for the camera module of claim 8, wherein an upper gain limit value of a transfer function of the driving signal to the input signal is decreased at a gradient of −20 dB/decade or less in a frequency region greater than 1 kHz.

16. The driving controller for the camera module of claim 8, wherein a lower gain limit value of a transfer function of the driving signal to the input signal is 0 dB or more at 100 Hz or less.

17. The driving controller for the camera module of claim 8, wherein the controlling part performs at least one of a control using a proportional integral derivative (PID) scheme and a control using a low pass filter scheme.

18. The driving controller for the camera module of claim 8, wherein the controlling part includes a driver integrated circuit (IC) applying the driving signal to the coil and a sensor detecting a position of the magnet.

19. The driving controller for the camera module of claim 18, wherein the magnet includes a neutral zone formed in a portion of the magnet to allow for spatial division between a zone of the magnet having a first polarity and a zone of the magnet having a second polarity.

20. The driving controller for the camera module of claim 19, wherein the sensor is provided as a plurality of sensors, and the plurality of sensors are disposed to be spaced apart from each other in a height direction of the magnet.

21. The driving controller for the camera module of claim 19, wherein the sensor is disposed to be offset to one side with respect to a vertical bisector of the magnet.

22. The driving controller for the camera module of claim 19, wherein the zone of the magnet having the first polarity, the neutral zone, and the zone of the magnet having the second polarity are sequentially formed in the optical axis direction.

23. A camera module comprising:
a lens barrel comprising a lens;
a driving part configured to drive the lens barrel in an optical axis direction;
a ball bearing guiding movement of the lens barrel;
a semi-wet lubricant applied to the ball bearing; and
a controlling part configured to generate a driving signal in response to an input signal to control the driving part,
wherein a gain crossover frequency of a transfer function of an output signal to the input signal depending on driving of the driving part is 50 Hz to 300 Hz.

24. The camera module of claim 23, further comprising a housing accommodating the lens barrel, wherein the lens barrel includes a first rolling surface and the housing includes a second rolling surface, and
the first and second rolling surfaces contact the ball bearing.

25. The camera module of claim 24, wherein a hardness of the at least one ball bearing is greater than a hardness of the first and second rolling surfaces.

26. The camera module of claim 24, wherein the semi-wet lubricant is applied to the first and second rolling surfaces.

27. The camera module of claim 23, wherein the driving part includes a magnet provided on one side surface of the lens barrel and a coil disposed to face the magnet.

28. The camera module of claim 27, wherein the controlling part includes a driver IC applying the driving signal to the coil and a sensor detecting a position of the magnet.

29. The camera module of claim 28, wherein the driver IC and the sensor are formed integrally with each other and are disposed outwardly of the coil.

30. The camera module of claim 28, wherein the driver IC and the sensor are formed integrally with each other and are disposed in a hollow part of the coil.

31. The camera module of claim 28, wherein the driver IC and the sensor are disposed outwardly of the coil.

32. The camera module of claim 28, wherein the driver IC is disposed outwardly of the coil, and the sensor is disposed in a hollow part of the coil.

33. A camera module comprising:
a lens barrel including a lens;
a driving part configured to move the lens barrel from an initial position to a target position; and
a controlling part configured to control the driving part in at least one of an initial operation mode, an auto-focusing mode, and a maintaining mode in response to an input signal,
wherein in the auto-focusing mode, a settling time required for moving the lens barrel from the initial position to the target position is 12 msec.

34. The camera module of claim 33, wherein in the auto-focusing mode, a gain crossover frequency of an upper gain limit value of a transfer function of an output signal of the driving part to the input signal is 300 Hz or less, and a lower gain limit value of the transfer function of the output signal of the driving part to the input signal is 50 Hz or more.

35. The camera module of claim 34, wherein in the auto-focusing mode, the upper gain limit value and the lower gain limit value of the transfer function of the output signal of the driving part to the input signal are respectively decreased at a gradient of −40 dB/decade or less in a frequency region having a frequency greater than the gain crossover frequency of the upper gain limit value.

36. The camera module of claim 34, wherein in the auto-focusing mode, a phase margin of the transfer function of the output signal of the driving part to the input signal is 45 degrees or more, and a gain margin of the transfer function of the output signal of the driving part to the input signal is 10 dB or more.

37. The camera module of claim 33, further comprising a semi-wet lubricant applied to at least one of a first rolling surface provided on a housing accommodating the lens barrel in the housing, a second rolling surface provided on the lens barrel, and at least one ball bearing disposed between the first and second rolling surfaces to contact the first and second rolling surfaces.

38. The camera module of claim 37, wherein the semi-wet lubricant is prepared by mixing a solvent with a lubricant, applying a mixture of the solvent and the lubricant to at least one of a surface of the at least one ball bearing and the first and second rolling surfaces, and then evaporating and removing the solvent at room temperature.

39. The camera module of claim 37, wherein the semi-wet lubricant is a fluorine-based lubricant.

40. The camera module of claim 37, wherein the semi-wet lubricant contains polytetrafluoroethylene (PTFE).

41. The camera module of claim 37, wherein the semi-wet lubricant is a silicon-based lubricant.

42. The camera module of claim 37, wherein a thickness of the semi-wet lubricant is 0.5 to 10 μm.

43. The camera module of claim 37, wherein kinematic viscosity of the semi-wet lubricant is 400 cSt to 900 cSt at a temperature of 40° C.

44. The camera module of claim 37, wherein flow-down of the semi-wet lubricant is 3 cm or less.

45. A camera module comprising:
a holder comprising a lens barrel;
a housing accommodating the holder therein;
a ball bearing contacting rolling surfaces, which are respectively provided on the holder and the housing; and
a semi-wet lubricant applied to a surface of the ball bearing.

46. The camera module of claim 45, wherein the semi-wet lubricant is at least one of a silicon-based lubricant and a fluorine-based lubricant.

47. The camera module of claim 45, wherein the semi-wet lubricant contains polytetrafluoroethylene (PTFE).

48. The camera module of claim 45, wherein the semi-wet lubricant is applied to the rolling surfaces provided on the holder and the housing.

49. The camera module of claim 45, wherein a thickness of the semi-wet lubricant is 0.5 to 10 μm.

50. The camera module of claim 45, wherein a kinematic viscosity of the semi-wet lubricant is 400 cSt to 900 cSt at a temperature of 40° C.

51. The camera module of claim 45, wherein flow-down of the semi-wet lubricant is 3 cm or less.

52. The driving controller for the camera module of claim 8, wherein the driving part is configured to move the lens barrel by electromagnetic interaction between the magnet and the coil.
